(19) United States
(12) Patent Application Publication
(10) Pub. No.: US 2013/0150516 A1
(43) Pub. Date: Jun. 13, 2013

(54) Rubber Compositions Comprising Graphene and Reinforcing Agents and Articles Made Therefrom

(71) Applicant: John S. Lettow, Washington, DC (US)

(72) Inventor: John S. Lettow, Washington, DC (US)

(73) Assignee: Vorbeck Materials Corp., Jessup, MD (US)

(21) Appl. No.: 13/712,948

(22) Filed: Dec. 12, 2012

Related U.S. Application Data
(60) Provisional application No. 61/569,435, filed on Dec. 12, 2011.

(51) Int. Cl. C08K 3/04; C08K 3/36

(52) U.S. Cl. CPC C08K 3/04; C08K 3/36
USPC 524/495; 524/571; 524/574; 524/575; 524/575.5

(57) ABSTRACT

Compositions comprising graphene sheets. at least one reinforcing agent, and at least one rubber. The compositions may further comprise carbon black. The compositions may be formed into articles including tire components.

### REFERENCE TO RELATED APPLICATIONS

The present application claims priority to U.S. Provisional Applications 61/569,435, filed on Dec. 12, 2011, the entire contents of which are hereby incorporated by reference.

### FIELD OF THE INVENTION

The present invention relates to rubber compositions comprising graphene and reinforcing agents, and articles comprising the compositions.

### BACKGROUND

Rubber goods are used in all areas of life, including tires, belts, industrial applications, automotive components, clothing, etc. Enhanced physical properties of rubbers such as wear resistance, durability, etc. are desirable for many of these applications. Considerable research and development work is being done to increase the fuel efficiency of vehicles. A significant contributor to decreased fuel efficiency is the energy lost through rolling resistance between tires and the road surface. A portion of rolling resistance is caused by hysteresis, i.e., the energy dissipated when tire components deform and then recover as the tire rolls. It would be desirable to obtain a rubber composition having improved mechanical properties, such as decreased hysteresis.

### SUMMARY OF THE INVENTION

Disclosed and claimed herein are compositions comprising graphene sheets, at least one silicon containing reinforcing agent, and at least one rubber and articles, such as tired made therefrom. Further disclosed and claimed is a method of making a rubber composition, comprising the step of blending graphene sheets, at least one silicon containing reinforcing agent, and at least one rubber.

### DETAILED DESCRIPTION OF THE INVENTION

As used herein, the term “phr” refers to parts per hundred parts of rubber.

Examples of reinforcing agents include mineral fillers. Examples of mineral fillers include silicon-containing compounds, such as silicas, silicates, clays, nanoclays, etc. Examples include glasses, aluminum silicates, wollastonites, kaolins, montmorillonites (including nanoclays), halloysite (including nanoclays), chlorite, calcined clay, etc. Examples of mineral fillers include talc, mica, carbonates (such as calcium carbonate, precipitated calcium carbonate, magnesium carbonate, barium carbonate, dolomites, huntite, hydromagnesite, etc.), sulfates (such as barium sulfate), barites, brucite, magnesium hydroxide, alumina trihydrate, etc.

Reinforcing agents can include polymers (such as polyaramides (including Kevlar®), ultra high molecular weight polyethylene (including Dynema®), etc. Reinforcing agents can be carbon fillers other than graphene sheets, including carbon black, carbon nanotubes, etc.

The compositions may also comprise carbon black, including low- and high-structure carbon blacks. Carbon blacks may be surface modified.

Reinforcing agents can be in the form of fibers, including chopped fibers (such as glass, carbon, polyaramide, ultra high molecular weight polyethylene), nanotubes (including carbon nanotubes (such as single- and double-walled nanotubes), silicates, etc.), etc. They can be in the form of mats or weaves of fibers.

Examples of suitable forms of silica include, but are not limited to, pyrogenic silicas, crystalline silicas, amorphous silicas, precipitated silicas, quartz, etc. They may be formed by the acidification of a silicate such as sodium silicate, etc. The silicas include conventional, easily dispersible or semi-HD, and highly dispersible (HD) silicas. The silicas may be nanosilicas.

The reinforcing agents can be surface modifiers.

In some embodiments, particularly when low surface area fillers (such as mineral fillers, silicon-containing agents, carbon blacks, graphite), etc. are used, the composition may comprise from about 1 phr to about 100 phr of filler, or about 10 to about 100 phr of filler, or about 20 to about 100 phr of filler, or about 30 to about 100 phr of filler, or about 40 to about 100 phr of filler, or about 50 to about 100 phr of filler, or about 60 to about 100 phr of filler, or about 10 to about 80 phr of filler, or about 20 to about 80 phr of filler, or about 30 to about 80 phr of filler, or about 40 to about 80 phr of filler, or about 50 to about 80 phr, or about 60 to about 90 phr of filler.

Some preferred loadings for carbon black include 0.1 to about 100 phr, or about 1 to about 80 phr, or about 5 to about 80 phr, or about 10 to about 80 phr, or about 5 to about 60 phr, or about 10 to about 80 phr, or about 20 to about 80 phr, or about 30 to about 80 phr, or about 15 to about 60 phr, or about 20 to about 60 phr, or about 15 to about 50 phr, or about 20 to about 40 phr.

In some embodiments, particularly when high surface area fillers (such as nanoclays, carbon nanotubes, etc.), etc. are used, the composition may comprise from about 0.5 phr to about 10 phr, or about 1 to about 8 phr, or about 1 to about 5 phr, or about 2 to about 4 phr, or about 2 to about 3 phr of filler.

Preferred fillers include blends of carbon black with one or more other fillers, silicon containing compounds, silicas, and blends of silicon containing compounds and silicas with carbon black.

Rubbers can be thermosets, thermoplastics, etc. Examples of rubbers include one or more of natural rubbers, polyisoprene, cis-1,4-polyisoprene, high cis-1,4-polyisoprene, isoprene/isobutylene rubbers, isoprene/butadiene polymers, acrylonitrile/butadiene rubber, hydrogenated acrylonitrile/butadiene rubber (HNBR), acrylic rubber, ethylene/acrylic elastomers, isobutylene-co-para-methylisoprene, brominated isobutylene-co-para-methylisoprene, neoprene (chloroprene), polybutadiene, 1,4-polybutadiene, high cis-1,4-polybutadiene rubbers, low cis-1,4-polybutadiene rubbers, high-vinyl polybutadiene rubbers, ethylene/propylene/diene rubbers (EPDM), ethylene/propylene rubbers (EPM), chlorosulfonated polyethylene (CSM), styrenic copolymers, styrenic block copolymers, styrene/isoprene/styrene (SIS) rubbers, /butadiene rubbers (SBR), styrene-butadiene rubbers prepared by emulsion polymerization, styrene-butadiene rubbers prepared by solution polymerization, styrene/ethylene/butadiene/styrene copolymer (SEBS), ethylene/vinyl acetate (EVA) polymers, butyl rubbers, chlorobutyl rubbers, bromobutyl rubbers, chlorohalogenated butyl rubbers, branched butyl rubbers, star-branched butyl rubbers, ethylene/propylene rubbers, chlorosulfonated polyethylenes, nitrile rubbers, hydrogenated nitrile rubbers, carboxylated nitrile rubbers, acrylic rubbers, hydrin rubbers, fluoroelastomers, fluorocarbon rubbers, polyphosphazenes, polysulfide rubber, polyurethane rubbers, polysiloxanes, natural rubber and solution SBR blends, low Tg polybutadiene and SBR blends, etc. Thermoplastic elastomers, such as thermoplastic polyurethane, poly(vinyl chloride) (PVC), PVC/nitrile rubber blends, styrenic block copolymers, copolyester elastomers, copolyetherester elastomers, thermoplastic vulcanizates (e.g., polypropylene/EPDM, polypropylene/nitrile rubber, etc.), copolyamide elastomers, etc.

The graphene sheets are graphite sheets preferably having a surface area of from about 100 to about 2630 m²/g. In some embodiments, the graphene sheets primarily, almost completely, or completely comprise fully exfoliated single sheets of graphite (these are approximately ≦1 nm thick and are often referred to as “graphene”), while in other embodiments, at least a portion of the graphene sheets may comprise partially exfoliated graphite sheets, in which two or more sheets of graphite have not been exfoliated from each other. The graphene sheets may comprise mixtures of fully and partially exfoliated graphite sheets. Graphene sheets are distinct from carbon nanotubes. Graphene sheets may have a “platey” (e.g. two-dimensional) structure and do not have the needle-like form of carbon nanotubes. The two longest dimensions of the graphene sheets may each be at least about 10 times greater, or at least about 50 times greater, or at least about 100 times greater, or at least about 1000 times greater, or at least about 5000 times greater, or at least about 10,000 times greater than the shortest dimension (i.e. thickness) of the sheets.

Graphene sheets may be made using any suitable method. For example, they may be obtained from graphite, graphite oxide, expandable graphite, expanded graphite, etc. They may be obtained by the physical exfoliation of graphite, by for example, peeling, grinding, milling, graphene sheets. They made be made by sonication of precursors such as graphite. They may be made by opening carbon nanotubes. They may be made from inorganic precursors, such as silicon carbide. They may be made by chemical vapor deposition (such as by reacting a methane and hydrogen on a metal surface). They may be made by epitaxial growth on substrates such as silicon carbide and metal substrates and by growth from metal-carbon melts. They made by made They may be may by the reduction of an alcohol, such ethanol, with a metal (such as an alkali metal like sodium) and the subsequent pyrolysis of the alkoxide product (such a method is reported in Nature Nanotechnology (2009), 4, 30-33). They may be made from small molecule precursors such as carbon dioxide, alcohols (such as ethanol, methanol, etc.), alkoxides (such as ethoxides, methoxides, etc., including sodium, potassium, and other alkoxides). They may be made by the exfoliation of graphite in dispersions or exfoliation of graphite oxide in dispersions and the subsequently reducing the exfoliated graphite oxide. Graphene sheets may be made by the exfoliation of expandable graphite, followed by intercalation, and ultrasonication or other means of separating the intercalated sheets (see, for example, Nature Nanotechnology (2008), 3, 538-542). They may be made by the intercalation of graphite and the subsequent exfoliation of the product in suspension, thermally, etc. Exfoliation processes may be thermal, and include exfoliation by rapid heating, using microwaves, furnaces, hot baths, etc.

Graphene sheets may be made from graphite oxide (also known as graphitic acid or graphene oxide). Graphite may be treated with oxidizing and/or intercalating agents and exfoliated. Graphite may also be treated with intercalating agents and electrochemically oxidized and exfoliated. Graphene sheets may be formed by ultrasonically exfoliating suspensions of graphite and/or graphite oxide in a liquid (which may contain surfactants and/or intercalants). Exfoliated graphite oxide dispersions or suspensions can be subsequently reduced to graphene sheets. Graphene sheets may also be formed by mechanical treatment (such as grinding or milling) to exfoliate graphite or graphite oxide (which would subsequently be reduced to graphene sheets).

Graphene sheets may be made by the reduction of graphite oxide. Reduction of graphite oxide to graphene may be done by thermal reduction/annealing, chemical reduction, etc. and may be carried out on graphite oxide in a solid form, in a dispersion, etc. Examples of useful chemical reducing agents include, but are not limited to, hydrazines (such as hydrazine (in liquid or vapor forms, N,N-dimethylhydrazine, etc.), sodium borohydride, citric acid, hydroquinone, isocyanates (such as phenyl isocyanate), hydrogen, hydrogen plasma, etc. A dispersion or suspension of exfoliated graphite oxide in a carrier (such as water, organic solvents, or a mixture of solvents) can be made using any suitable method (such as ultrasonication and/or mechanical grinding or milling) and reduced to graphene sheets. Reduction can be solvothermal reduction, in solvents such as water, ethanol, etc. This can for example be done in an autoclave at elevated temperatures (such as those above about 200° C.).

Graphite oxide may be produced by any method known in the art, such as by a process that involves oxidation of graphite using one or more chemical oxidizing agents and, optionally, intercalating agents such as sulfuric acid. Examples of oxidizing agents include nitric acid, sodium and potassium nitrates, perchlorates, hydrogen peroxide, sodium and potassium permanganates, phosphorus pentoxide, bisulfites, etc. Preferred oxidants include KClO₄; HNO₃ and KClO₃; KMnO₄ and/or NaMnO₄; KMnO₄ and NaNO₃; K₂S₂O₈ and P₂O₅ and KMnO₄; KMnO₄ and HNO₃; and HNO₃. Preferred intercalation agents include sulfuric acid. Graphite may also be treated with intercalating agents and electrochemically oxidized. Examples of methods of making graphite oxide include those described by Staudenmaier (Ber. Stsch. Chem. Ges. (1898), 31, 1481) and Hummers (J. Am. Chem. Soc. (1958), 80, 1339).

One example of a method for the preparation of graphene sheets is to oxidize graphite to graphite oxide, which is then thermally exfoliated to form graphene sheets (also known as thermally exfoliated graphite oxide), as described in US 2007/0092432, the disclosure of which is hereby incorporated herein by reference. The thusly formed graphene sheets may display little or no signature corresponding to graphite or graphite oxide in their X-ray diffraction pattern.

The thermal exfoliation may be carried out in a continuous, semi-continuous batch, etc. process.

Heating can be done in a batch process or a continuous process and can be done under a variety of atmospheres, including inert and reducing atmospheres (such as nitrogen, argon, and/or hydrogen atmospheres). Heating times can range from under a few seconds or several hours or more, depending on the temperatures used and the characteristics desired in the final thermally exfoliated graphite oxide. Heating can be done in any appropriate vessel, such as a fused silica, mineral, metal, carbon (such as graphite), ceramic, etc. vessel. Heating may be done using a flash lamp. During heating, the graphite oxide may be contained in an essentially constant location in single batch reaction vessel, or may be transported through one or more vessels during the reaction in a continuous or batch mode. Heating may be done using any suitable means, including the use of furnaces and infrared heaters.

Examples of temperatures at which the thermal exfoliation of graphite oxide may be carried out are at least about 300° C., at least about 400° C., at least about 450° C., at least about 500° C., at least about 600° C., at least about 700° C., at least about 750° C., at least about 800° C., at least about 850° C., at least about 900° C., at least about 950° C., and at least about 1000° C. Preferred ranges include between about 750 about and 3000° C., between about 850 and 2500° C., between about 950 and about 2500° C., and between about 950 and about 1500° C.

The time of heating can range from less than a second to many minutes. For example, the time of heating can be less than about 0.5 seconds, less than about 1 second, less than about 5 seconds, less than about 10 seconds, less than about 20 seconds, less than about 30 seconds, or less than about 1 min. The time of heating can be at least about 1 minute, at least about 2 minutes, at least about 5 minutes, at least about 15 minutes, at least about 30 minutes, at least about 45 minutes, at least about 60 minutes, at least about 90 minutes, at least about 120 minutes, at least about 150 minutes, at least about 240 minutes, from about 0.01 seconds to about 240 minutes, from about 0.5 seconds to about 240 minutes, from about 1 second to about 240 minutes, from about 1 minute to about 240 minutes, from about 0.01 seconds to about 60 minutes, from about 0.5 seconds to about 60 minutes, from about 1 second to about 60 minutes, from about 1 minute to about 60 minutes, from about 0.01 seconds to about 10 minutes, from about 0.5 seconds to about 10 minutes, from about 1 second to about 10 minutes, from about 1 minute to about 10 minutes, from about 0.01 seconds to about 1 minute, from about 0.5 seconds to about 1 minute, from about 1 second to about 1 minute, no more than about 600 minutes, no more than about 450 minutes, no more than about 300 minutes, no more than about 180 minutes, no more than about 120 minutes, no more than about 90 minutes, no more than about 60 minutes, no more than about 30 minutes, no more than about 15 minutes, no more than about 10 minutes, no more than about 5 minutes, no more than about 1 minute, no more than about 30 seconds, no more than about 10 seconds, or no more than about 1 second. During the course of heating, the temperature may vary.

Examples of the rate of heating include at least about 120° C./min, at least about 200° C./min, at least about 300° C./min, at least about 400° C./min, at least about 600° C./min, at least about 800° C./min, at least about 1000° C./min, at least about 1200° C./min, at least about 1500° C./min, at least about 1800° C./min, and at least about 2000° C./min.

Graphene sheets may be annealed or reduced to graphene sheets having higher carbon to oxygen ratios by heating under reducing atmospheric conditions (e.g., in systems purged with inert gases or hydrogen). Reduction/annealing temperatures are preferably at least about 300° C., or at least about 350° C., or at least about 400° C., or at least about 500° C., or at least about 600° C., or at least about 750° C., or at least about 850° C., or at least about 950° C., or at least about 1000° C. The temperature used may be, for example, between about 750 about and 3000° C., or between about 850 and 2500° C., or between about 950 and about 2500° C.

The time of heating can be for example, at least about 1 second, or at least about 10 second, or at least about 1 minute, or at least about 2 minutes, or at least about 5 minutes. In some embodiments, the heating time will be at least about 15 minutes, or about 30 minutes, or about 45 minutes, or about 60 minutes, or about 90 minutes, or about 120 minutes, or about 150 minutes. During the course of annealing/reduction, the temperature may vary within these ranges.

The heating may be done under a variety of conditions, including in an inert atmosphere (such as argon or nitrogen) or a reducing atmosphere, such as hydrogen (including hydrogen diluted in an inert gas such as argon or nitrogen), or under vacuum. The heating may be done in any appropriate vessel, such as a fused silica or a mineral or ceramic vessel or a metal vessel. The materials being heated including any starting materials and any products or intermediates) may be contained in an essentially constant location in single batch reaction vessel, or may be transported through one or more vessels during the reaction in a continuous or batch reaction. Heating may be done using any suitable means, including the use of furnaces and infrared heaters.

The graphene sheets preferably have a surface area of at least about 100 m²/g to, or of at least about 200 m²/g, or of at least about 300 m²/g, or of least about 350 m²/g, or of least about 400 m²/g, or of least about 500 m²/g, or of least about 600 m²/g., or of least about 700 m²/g, or of least about 800 m²/g, or of least about 900 m²/g, or of least about 700 m²/g. The surface area may be about 400 to about 1100 m²/g. The theoretical maximum surface area can be calculated to be 2630 m²/g. The surface area includes all values and subvalues therebetween, especially including 400, 500, 600, 700, 800, 900, 1000, 1100, 1200, 1300, 1400, 1500, 1600, 1700, 1800, 1900, 2000, 2100, 2200, 2300, 2400, 2500, and 2630 m²/g.

The graphene sheets can have number average aspect ratios of about 100 to about 100,000, or of about 100 to about 50,000, or of about 100 to about 25,000, or of about 100 to about 10,000 (where “aspect ratio” is defined as the ratio of the longest dimension of the sheet to the shortest).

Surface area can be measured using either the nitrogen adsorption/BET method at 77 K or a methylene blue (MB) dye method in liquid solution.

The dye method is carried out as follows: A known amount of graphene sheets is added to a flask. At least 1.5 g of MB are then added to the flask per gram of graphene sheets. Ethanol is added to the flask and the mixture is ultrasonicated for about fifteen minutes. The ethanol is then evaporated and a known quantity of water is added to the flask to re-dissolve the free MB. The undissolved material is allowed to settle, preferably by centrifuging the sample. The concentration of MB in solution is determined using a UV-vis spectrophotometer by measuring the absorption at λₘₐₓ=298 nm relative to that of standard concentrations.

The difference between the amount of MB that was initially added and the amount present in solution as determined by UV-vis spectrophotometry is assumed to be the amount of MB that has been adsorbed onto the surface of the graphene sheets. The surface area of the graphene sheets are then calculated using a value of 2.54 m² of surface covered per one mg of MB adsorbed.

The graphene sheets can have a bulk density of from about 0.01 to at least about 200 kg/m³. The bulk density includes all values and subvalues therebetween, especially including 0.05, 0.1, 0.5, 1, 5, 10, 15, 20, 25, 30, 35, 50, 75, 100, 125, 150, and 175 kg/m³.

The graphene sheets may be functionalized with, for example, oxygen-containing functional groups (including, for example, hydroxyl, carboxyl, and epoxy groups) and typically have an overall carbon to oxygen molar ratio (C/O ratio), as determined by bulk elemental analysis, of at least about 1:1, or more preferably, at least about 3:2. Examples of carbon to oxygen ratios include about 3:2 to about 85:15; about 3:2 to about 20:1; about 3:2 to about 30:1; about 3:2 to about 40:1; about 3:2 to about 60:1; about 3:2 to about 80:1; about 3:2 to about 100:1; about 3:2 to about 200:1; about 3:2 to about 500:1; about 3:2 to about 1000:1; about 3:2 to greater than 1000:1; about 10:1 to about 30:1; about 80:1 to about 100:1; about 20:1 to about 100:1; about 20:1 to about 500:1; about 20:1 to about 1000:1; about 50:1 to about 300:1; about 50:1 to about 500:1; and about 50:1 to about 1000:1. In some embodiments, the carbon to oxygen ratio is at least about 10:1, or at least about 15:1, or at least about 20:1, or at least about 35:1, or at least about 50:1, or at least about 75:1, or at least about 100:1, or at least about 200:1, or at least about 300:1, or at least about 400:1, or at least 500:1, or at least about 750:1, or at least about 1000:1; or at least about 1500:1, or at least about 2000:1. The carbon to oxygen ratio also includes all values and subvalues between these ranges.

The graphene sheets may contain atomic scale kinks. These kinks may be caused by the presence of lattice defects in, or by chemical functionalization of the two-dimensional hexagonal lattice structure of the graphite basal plane.

The compositions may be electrically conductive. In some embodiments, the surface resistivity of the compositions may be no greater than about 10000 Ω/square, or no greater than about 5000 Ω/square, or no greater than about 1000 Ω/square, or no greater than about 700 Ω/square, or no greater than about 500 Ω/square, or no greater than about 350 Ω/square, or no greater than about 200 Ω/square, or no greater than about 200 Ω/square, or no greater than about 150 Ω/square, or no greater than about 100 Ω/square, or no greater than about 75 Ω/square, or no greater than about 50 Ω/square, or no greater than about 30 Ω/square, or no greater than about 20 Ω/square, or no greater than about 10 Ω/square, or no greater than about 5 Ω/square, or no greater than about 1 Ω/square, or no greater than about 0.1 Ω/square, or no greater than about 0.01 Ω/square, or no greater than about 0.001 Ω/square.

The compositions may have an electrical conductivity of at least about 10⁻⁸ S/m. They can have a conductivity of about 10⁻⁶ S/m to about 10⁵ S/m, or of about 10⁻⁵ S/m to about 10⁵ S/m. In other embodiments of the invention, the compositions have conductivities of at least about 0.001 S/m, of at least about 0.01 S/m, of at least about 0.1 S/m, of at least about 1 S/m, of at least about 10 S/m, of at least about 100 S/m, or at least about 1000 S/m, or at least about 10,000 S/m, or at least about 20,000 S/m, or at least about 30,000 S/m, or at least about 40,000 S/m, or at least about 50,000 S/m, or at least about 60,000 S/m, or at least about 75,000 S/m, or at least about 10⁵ S/m, or at least about 10⁶ S/m.

In some embodiments, the compositions can have a thermal conductivity of about 0.1 to about 50 W/(m−K), or of about 0.5 to about 30 W/(m−K), or of about 1 to about 30 W/(m−K), or of about 1 to about 20 W/(m−K), or of about 1 to about 10 W/(m−K), or of about 1 to about 5 W/(m−K), or of about 2 to about 25 W/(m−K), or of about 5 to about 25 W/(m−K).

In some embodiments, the composition may comprise about 0.1 to about 20 phr, or about 0.5 to about 20 phr, or about 0.5 to about 15 phr, or about 0.5 to about 10 phr, or about 1 to about 15 phr, or about 1 to about 10 phr, or about 1 to about 7 phr, or about 1 to about 5 phr, or about 2 to about 5 phr of graphene sheets.

The compositions may further comprise one or more additional additives, such as cross-linkers, curing agents, and vulcanizers (including sulfur and sulfur-containing compounds, peroxides, epoxides, bisphenol, diamines, metal oxides, etc.), accelerators, stabilizers, antidegredation agents (including antioxidants, anti-ozone materials, etc.), zinc oxide, fatty acids (such as stearic acid), scorch inhibitors, tackifiers, waxes, oils, processing aids, fillers (such as clay, talc, etc.) other resins (including phenolics), peptizers, coupling agents (such as silane coupling agents), etc.

Sulfur and/or sulfur-containing compounds may in some instances be present in the compositions in from about 0.05 to about 5 phr, or from about 0.1 to about 5 phr, or from about 0.25 to about 5 phr, or from about 0.05 to about 2.5 phr, or from about 0.1 to about 2.5 phr, or from about 0.25 to about 2.5 phr, or from about 0.5 to about 2.5 phr, or from about 0.05 to about 1 phr, or from about 0.1 to about 1 phr, or from about 0.5 to about 1 phr.

Coupling agents include organosilicon (silane) compounds, particularly those containing functional groups that can interact with the rubber. Examples of functional groups include mercapto, amino, vinyl, epoxy, sulfur, etc. groups. Examples include di- and polysulfides, bis-(trialkoxysilylalkyl) polysulfides having from 2 to about 8 connecting sulfur atoms in their sulfur bridge, bis-(3-triethoxysilylpropyl)tetrasulfide (TESPT), bis-(3-triethoxysilylpropyl)trisulfide, bis-(3-triethoxysilylpropyl) disulfide (TESPD), 3-chloropropyltriethoxysilane (CPTEO), 3-aminipropyltriethoxysilane (AMEO), vinyltrimethoxysilane, vinyltriethoxysilane, 3-mercaptopropyltrimethoxysilane, 3-methacryloxypropyltrimethoxysilane, blocked silanes (such as blocked mercaptosilanes), etc.

Examples of accelerators include N-tert-butyl-2-benzothiazole sulfonamide (TBBS), benzothiazyl disulfide (MBTS), N-cyclohexyl-2-benzothiazole sulfonamide (CBS), diphenylguanidine (DPG), etc.

The compositions may be prepared using any suitable method, including conventional rubber processing techniques. Some or all of the components may be blended and combined with one or more vulcanizing, crosslinking, or curing agents and heat treated. Graphene sheets and/or other components may be combined with the rubber by polymerizing the rubber in the presence of graphene sheets and/or other components (in situ polymerization). Rubber containing graphene sheets and/or other components may be blended with additional components, including additional graphene sheets and/or the other components. The compositions may be in vulcanized or unvulcanized form. Rubber (and/or rubber precursors), silica, graphene sheets, and any other components may be directly blended with each other in one or more steps.

The compositions may be formed into a variety of articles, including tires. The term “tires” is meant to include fully assembled tires as wells tire components, such as treads, belts, sidewalls, inner liners, etc. and fully assembled tires containing one or more of these components.

Tires may be non-pneumatic tires and pneumatic tires, including radial tires, bias ply tires, tubeless tires, solid tires, run-flat tires, etc. For examples, the tires may be used in motorized vehicles, equipment, and accessories such as automobiles, trucks, racing vehicles, motorcycles, mopeds, all terrain vehicles, golf carts, off-read vehicles, construction equipment, earthmovers, dump trucks, lawn mowers, farm equipment, tractors, harvesters, trailers, wheelchairs, aircraft, forklifts, lift trucks, tanks, aviation (such as airplanes, helicopters, etc.), etc. They may be used in non-motorized motorized vehicles, equipment, and accessories such as bicycles, tricycles, unicycles, wheelchairs, wheel barrows, carts, etc.

The compositions may be used in footwear, including footwear soles. Footwear can include boots, athletic shoes, safety shoes, etc.

They may be used in seals, cables, profiles, hoses, industrial rubber goods, belts, conveyer belts, power transmission belts, rollers, floor coverings, golf balls, windows, vibration control applications (such as earthquake protection equipment (such as rubber bearings), floors, walls, windows, helicopter vibration dampeners, etc.).

They may be used in automotive applications such as engine mounts, belts (including timing belts, drive belts, transmission belts, etc.), airsprings, seals, hoses, tubes, cables, etc.

### EXAMPLES

The stage 1 components in Table 1 are blended in a two-roll mill. The stage 3 components in Table 1 are then added. In the case of Examples 1-3, graphene sheets are added to the compositions in the amounts indicated in Table 2. Sheets are rolled out of the mill and cured.

The physical properties of the sheets are measured and the results are given in Table 2. Rheological properties of the compositions are measured using a rubber process analyzer (RPA) at 40° C. Shear modulus (G*) in kPa and tan delta results for strain sweep experiments (run at a frequency of 1.7 Hz) and frequency sweep (run at a strain of 7%) experiments are given in Tables 3 and 4, respectively.

TABLE 1

| | phr |
|---|---|
| Stage 1 | |
| solution-SBR (25% styrene, 73% | 96 |
| vinyl, 27% oil) | |
| BR (cis-1,4 BR) | 30 |
| Precipitated silica (Evonik/Degussa | 80 |
| Ultrasil 7000GR or VN3 GR) | |
| Silane/Carbon black | 12.8 |
| (Evonik/Degussa X 50-S, 1:1 ratio | |
| of silane S69, and carbon black | |
| N330) | |
| ZnO | 3 |
| Stearic Acid | 2 |
| Wax | 1 |
| Aromatic Oil | 10 |
| Antioxidant (6-PPD) | 1.5 |
| Stage 3 | |
| Accelerator (CBS) | 1.5 |
| Accelerator (DPG) | 2 |
| Sulfur | 1.5 |

TABLE 2

| | | Comp Ex. 1 | Ex. 1 | Ex. 2 | Ex. 3 |
|---|---|---|---|---|---|
| Amount of graphene | phr | — | 2 phr | 5 phr | 10 phr |
| Hardness | Shore A | 56 | 69 | 74 | 83 |
| Density | g/cm3 | 1.192 | 1.197 | 1.201 | 1.21 |
| Stress at break | kgf/cm2 | 126 | 126 | 119 | 104 |
| Elongation at break | % | 949 | 853 | 682 | 432 |
| Modulus 100% | kgf/cm2 | 10 | 15 | 22 | 37 |
| Modulus 300% | kgf/cm2 | 20 | 34 | 52 | 81 |
| Mooney (1 + 4) | MU | 90.9 | 124.2 | 129.6 | 129.1 |
| 100° C. | | | | | |
| Tear resistance | kgf/cm | 49.9 | 51 | 58.7 | 36.9 |
| Abrasion resistance | mm3 | 183 | 183 | 183 | 194 |
| Rebound | % | 34 | 37 | 34 | 32 |
| Compression set | % | 65.2 | 59.2 | 57.7 | 70.1 |
| 100° C./24 h | | | | | |
| Air ageing 100° C./ | | | | | |
| 24 h | | | | | |
| Hardness change | Shore A | 11 | 7 | 4 | 2 |
| Stress change | % | 0 | 0 | −3 | 0 |
| Elongation change | % | −23.1 | −21.6 | −30.6 | −32.4 |

TABLE 3

| | Strain | Comp | | | |
|---|---|---|---|---|---|
| | (%) | Ex. 1 | Ex. 1 | Ex. 2 | Ex. 3 |
| G* | 0.7 | 3790 | 6041 | 8083 | 13143 |
| G* | 1.0 | 2730 | 4059 | 4771 | 7046 |
| G* | 3.0 | 2489 | 3695 | 4191 | 5793 |
| G* | 5.0 | 1624 | 2282 | 2573 | 3549 |
| G* | 7.0 | 1138 | 1571 | 1774 | 2397 |
| G* | 10 | 870 | 1182 | 1329 | 1774 |
| tan delta | 0.7 | 0.248 | 0.235 | 0.273 | 0.277 |
| tan delta | 1.0 | 0.265 | 0.271 | 0.321 | 0.39 |
| tan delta | 3.0 | 0.244 | 0.238 | 0.283 | 0.382 |
| tan delta | 5.0 | 0.321 | 0.344 | 0.392 | 0.497 |
| tan delta | 7.0 | 0.358 | 0.382 | 0.418 | 0.483 |
| tan delta | 10 | 0.380 | 0.406 | 0.438 | 0.476 |

TABLE 4

| | Frequency | | | | |
|---|---|---|---|---|---|
| | (Hz) | Comp Ex. 1 | Ex. 1 | Ex. 2 | Ex. 3 |
| G* | 33 | 3245 | 4384 | 5228 | 7649 |
| G* | 30 | 3176 | 4310 | 5180 | 7444 |
| G* | 25 | 3031 | 4134 | 4951 | 7075 |
| G* | 20 | 2871 | 3965 | 5716 | 6655 |
| G* | 15 | 2505 | 3581 | 4207 | 5745 |
| G* | 10 | 2153 | 3156 | 3693 | 4860 |
| tan delta | 33 | 0.227 | 0.245 | 0.26 | 0.288 |
| tan delta | 30 | 0.227 | 0.241 | 0.254 | 0.296 |
| tan delta | 25 | 0.232 | 0.246 | 0.26 | 0.32 |
| tan delta | 20 | 0.237 | 0.25 | 0.268 | 0.344 |
| tan delta | 15 | 0.257 | 0.262 | 0.286 | 0.38 |
| tan delta | 10 | 0.259 | 0.264 | 0.288 | 0.378 |

1. A composition, comprising graphene sheets, at least one silicon containing reinforcing agent, and at least one rubber.

2. The composition of claim 1, further comprising carbon black.

3. The composition of claim 1, wherein the reinforcing agent is silica.

4. The composition of claim 1, wherein the reinforcing agent is at least one silicate.

5. The composition of claim 1, wherein the rubber is one or more selected from the group consisting of natural rubbers. butyl rubbers. and styrene-butadiene rubbers. 1.4-polybutadiene rubbers.

6. The composition of claim 1, wherein the graphene sheets have a surface area of at least about 300 m²/g.

7. The composition of claim 1, wherein the graphene sheets have a surface area of at least about 400 m²/g.

8. The composition of claim 1, wherein the graphene sheets have a carbon to oxygen molar ratio of at least about 10:1.

9. The composition of claim 1, wherein the graphene sheets have a carbon to oxygen molar ratio of at least about 20:1.

10. The composition of claim 1, comprising about 0.1 to about 20 phr of graphene sheets.

11. The composition of claim 1, comprising about 0.5 to about 10 phr of graphene sheets.

12. A method of making a rubber composition, comprising the step of blending graphene sheets, at least one silicon containing reinforcing agent, and at least one rubber.

13. The method of claim 12, wherein the graphene sheets have a surface area of at least about 300 m²/g.

14. The method of claim 12, wherein the graphene sheets have a surface area of at least about 400 m²/g.

15. The method of claim 12, wherein the graphene sheets have a carbon to oxygen molar ratio of at least about 10:1.

16. The method of claim 12, wherein the composition comprises about 0.1 to about 20 phr of graphene sheets.

17. An article comprising the composition of claim 1.

18. The article of claim 17 in the form of a tire.

19. The tire of claim 18, having a tread, belt, sidewall, and/or inner liner, comprising a composition comprising graphene sheets, at least one silicon containing reinforcing agent, and at least one rubber.

20. The tire of claim 18, wherein the graphene sheets have a surface area of at least about 300 m²/g.
